(19) United States
(12) Patent Application Publication
(10) Pub. No.: US 2015/0051896 A1
(43) Pub. Date: Feb. 19, 2015

(54) Method and apparatus to construct program for assisting in reviewing

(71) Applicant: National Research Council of Canada, Ottawa (CA)

(72) Inventors: Michel Simard, Gatineau (CA); George Foster, Ottawa (CA)

(21) Appl. No.: 14/121,222

(22) Filed: Aug. 13, 2014

Related U.S. Application Data
(60) Provisional application No. 61/865,819, filed on Aug. 14, 2013.

(51) Int. Cl. G06F 17/28

(52) U.S. Cl. CPC G06F 17/289
USPC 704/2

(57) ABSTRACT

A technique for providing grammatical and semantic sense of statistical machine translation systems to assisting in reviewing tasks, provides for the construction of hypothesis generators and evaluators using sparse data, with the use of an edit distance metric for generating alignments of the sparse data.

### FIELD OF THE INVENTION

The present invention relates in general to natural language processing (NLP), and in particular to the construction of a computer program for assisting a human with manipulating or reviewing text. The program being constructed as a statistical machine translation (SMT) system built from sparse data.

### BACKGROUND OF THE INVENTION

Natural language processing (NLP) is an umbrella of artificial intelligence that deals with a wide variety of operations on text, including manipulations of text assist in reviewing. Herein assisting in reviewing means operations such as identifying or correcting errors or changing features, suggesting paraphrases, condensing or expanding expressions, or performing consistency checks, which are applied to atomic semantic units (ASUs) (i.e. words, word forms, morphemes, or other word-like, or phrase-like units), or compound semantic units (CSUs) (i.e. clause-like, sentence-like or similar) based on the ASUs contained therein.

Specific assisting in reviewing operations may be classified by the context of the task. For example, the text may have been produced by a machine rather than a human writer (e.g. by a translation memory system, an automatic text generation system or machine translation system), a voice to text system, or the draft may have been produced by a human with limited fluency in the language of the document, or indifferently to one or more requirements for the text.

Tasks such as identifying or correcting errors may be particularly important if recurrence of errors in the text arise systematically, which can occur for a number of reasons. For example, a draft written by an author who consistently makes the same mistake (e.g. incorrect spelling, incorrect diction) or by an automatic system whose dictionaries fail to cover adequately the relevant kind of text. Machine generated text is particularly prone to making consistent errors. Furthermore, many varieties of documents feature a substantial amount of repetition, as for example contracts, websites, patent applications, and user manuals all have (or may desirably have) fixed terms and referents. While the degree of repetitiousness of text varies greatly with style, content, and domain, it has been observed that if a segment repeats, it has the greatest chance of repeating within the same document (Church and Gale, 1995). This motivated development of translation memory systems with real-time update capabilities. Such systems archive each text segment as soon as it is processed by a translator, so that if it reappears within the same document, its most recent translation is immediately available for reuse.

So one particular example of an assisting in reviewing task is post editing of rule-base machine translation systems (Transformation-based Correction of Rule-based MT by Jakob Elming).

Artificial Intelligence has spawned a wide variety of techniques (under the partially overlapping umbrella of machine learning) that can observe a human revision of text, and catalog the changes made or not made, thereto, with a view to applying changes or suggestions to subsequent (not yet revised) text. The marking, or automatic correction, of unreviewed text may be made with a view to assisting or expediting the type of corrections made by a reviewer. In general, the problem amounts to this, given that a previous correction c1 has been made to an ASU1, in a CSU1, what, if anything, should be done to new ASU2 of CSU2, bearing some measure of similarity to ASU1 in CSU1.

US200910132911 teaches a technique for detecting errors in a document by first extracting editing patterns, defining correction rules, and developing classifiers of the rules. Editing patterns may be obtained by observing differences between draft documents and corresponding edited documents, and/or by observing editing operations performed on the draft documents to produce the edited documents. The editing pattern identifier may involve aligning the draft transcript with an edited transcript. The alignment may be performed from the structural level to the individual word level, with the assumption that document structure is preserved during editing. The example provided appears to be tied to fixed positions within transcripts, but no algorithm is given. Its authors recognized that the machine learning algorithms can be improved using context information.

U.S. Pat. No. 6,098,034 teaches semi-automatic identification of significant phrases in a document, and then finding other phrases that are similar enough according to an edit-distance, that they should be replaced.

Culotta et al. is a paper that describes exploiting user-feedback to continuously improve the performance of a machine learning system for correction propagation.

These machine learning techniques generally fail to encode, or use the relatively rich semantic and grammatical sense available in statistical machine translation (SMT) systems, opting for simpler rules, and less complex representations of the language aspects of the task. So the answers to the problem what, if anything, should be done to new phrase ASU2, bearing some measure of similarity to ASU1, is not informed by SMT's suite of language analysis tools.

SMT is a paradigm of machine translation (MT) characterized by a reliance on very large volumes of textual information (such as is readily available on the world-wide web) to generate statistics on word distributions in the language, and their orderings, and by an avoidance of linguist-generated rules. This paradigm results in the development of computation-intensive programs to determine the statistics from large corpora, and generates models for aspects of the SMT system. SMT systems are generated by applying known SMT methods to large bodies of text to generate statistics, including providing a large (sentence aligned) parallel corpus, word aligning, and phrase aligning the parallel corpus, and compiling the statistics to produce phrase tables, language models, and a variety of other components, and then using a developmental bilingual corpus to optimize a decoder for producing scores for candidate translations according to values assigned by the components.

Over the last few years, SMT systems have begun to be applied in different ways. While fundamentally SMT systems, like other MT systems, had been viewed essentially as translating between distinct source and target languages (i.e. where the source and target languages are different), Applicant has found that other MT output can be improved by using an SMT system that is geared to ‘translate’ the MT output, to better sentences of the same language (US20090326913). The SMT methods described above are almost inherently adapted to such uses if a suitable developmental bilingual corpus is given, whereas other MT systems are typically designed for translation between a language and itself. For example, US20100299132 teaches “monolingual translation” such as reformulation, paraphrasing and transliteration, and mention some important applications such as automatic suggestion of rephrasing, text compaction or expansion, summarization, all of which are examples of assisting in reviewing tasks. The suggestion to translate between one language and itself is also contained in Brockett et al. (2006) discussed below. Thus there are a range of new applications of SMT systems that are being considered. It is appreciated that the inherent grammatical and semantic sense provided by SMT systems can be leveraged to improve assisting in reviewing for a variety of NLP tasks.

Typically SMT systems are produced using a large training set with a large number of translated sentences. SMT methods work when the SMT models are trained on many sentence pairs, typically on the order of several millions of words, and at least on the order of 50,000 word pairs. In this art, tens of thousands of sentence pairs is considered to be sparse data. There is a whole subfield dedicated to translation with sparse data. Estimating statistics generally requires a large number of examples of many common word sequences, which is only provided with large corpora, so, the richer the training set, the better the models. Methods described by proponents of the SMT-based automatic post editing (APE) (Dugast et al., 2007; Terumasa, 2007; Schwenk et al., 2009; Lagarda et al., 2009; Béchara et al., 2011) are known to not perform well when very little training data is available.

In particular word/phrase alignment techniques are well known in the art of SMT systems, for identifying corresponding ASUs in sentence-aligned parallel bilingual corpora of training sets, prior to training of a translation model on the training set. The known techniques for alignment require a large number of ASUs so that statistics can be meaningfully assessed on the coincidence of source and target language ASUs. In current SMT systems, the aligner is typically implemented using “IBM models” (Brown et al., 1993).

Incremental adaptation of SMT systems has been explored in a post-editing context, beginning with Nepveu et al. (2004), who use a cache-based approach to incorporate recent word-for-word translations and n-grams into an early interactive SMT system. Hardt and Elming (2010) apply a similar strategy to a modern phrase-based SMT system, using heuristic IBM4-based word alignment techniques to augment a local phrase table with material from successive post-edited sentences. Two related themes in SMT research are general incremental training (Levenberg et al., 2010) and context-based adaptation without user feedback (Tiedemann, 2010; Gong et al., 2011). Outside the work of Hardt and Elming (2010), these techniques have not yet been applied to SMT post-editing or to the more general correction propagation problem.

The idea of dynamically updating an automatic correction system as sentences are revised by an editor, was the subject of an early proposal by Knight and Chander (1994). In the context of human post-editing of machine translation output, these authors propose the idea of an adaptive post editor, i.e., an automatic program that watches human post-edit MT documents, identifies errors that appear repeatedly, and emulate the human. They suggest that “SMT techniques” could be applied by such a program to learn the mapping between raw MT output and corresponding post-edited text, without describing how this would be accomplished.

Brockett et al. (2006) teaches a large-scale production SMT system used to correct a class of errors typical of learners of English as a Second Language (ESL). They employ a phrase-based SMT system that maps phrasal treelets to strings in the target. They showed that an engineered development corpus can be cobbled together from various sources, and used to train a SMT system which can then generally improve text from ESL learners. There were substantial pains taken to generate the development corpus from various sources, and to include unmodified sentences so that their training set is balanced. The next steps, according to Brockett et al., is to obtain a large dataset of pre and post-edited ESL text with which to train a model that does not rely on engineered data. It is noted that the engineered data induced artifacts in the SMT models.

It should be noted that obtaining large datasets of consistently edited, and unedited ESL learner's text at corresponding levels, is very difficult, even more difficult than large parallel bilingual documents. It is difficult to obtain such data, and the data is highly unstandardized, and the evaluations of levels would itself be difficult.

Along a similar vein, Dahlmeier et al. (EMNLP 2011, ACL 2011, WO 2012/039686) uses phrase-based SMTs for improving automatic correction of collocation errors in English learner texts. They pack the phrase-table of the SMT with synonyms, homophones, misspellings, and paraphrases, and show that they are better able to correct such text. The intuition behind this is that you identify phrases having semantic similarity between L1 and L2 languages, that are expressly not natural phrases in L2, and help the SMT to identify these errors, you can expedite correction of the L2 documents written by native speakers of L1.

Like Brockett et al., Dahlmeier et al. build an application-specific phrase table from a relatively small number of examples of sentences with collocation errors, these derived from a relatively large corpus. In the 52,149 sentence corpus, only 2,747 collocation errors were observed. This illustrates how difficult it would be to find reliable statistics on collocation errors, given the array of such errors and the paucity of examples.

So while SMT systems have features that are desirable for guiding assisting in reviewing tasks, the SMT methods are geared to deriving all components based on large corpora. Accordingly there is a need for an automated technique for generating a computer program for assisting (a reviewer) in reviewing text documents that incorporates SMT structures trained on operations performed by the reviewer.

### SUMMARY OF THE INVENTION

Applicant has devised a method for generating computer program for assisting in reviewing (CPAR) text documents that incorporates SMT structures trained on operations performed by the reviewer. In the summary and description of this invention, a document refers to a collection of text that is revised systematically, and not necessarily to a document in any other sense. For example, a collection of web pages pertaining to a software program, such as help files, or on any particular topic or variety of topics, will be considered a document. Another example of a document would be a large set of web pages such as provided by Wikipedia, for which consistent revision is desired.

The CPAR itself may be distinguishable as code from a SMT system only by a quantity of data in its ASU tables, or may assemble a particular collection of components that are not conventionally used for translating sentences of two languages. The generation of the CPAR involves using some SMT methods such as those used in phrase-based statistical machine translation, but uses a particular mechanism for alignment of data generated by the reviewer, during the previously performed operations.

Specifically the alignment technique on this sparse data is based on the use of an edit distance measure, which provides both a measure of similarity, and a partial mapping of ASUs from one CSU to another. The edit distance alignment accounts for the sparseness of data, and constitutes a completely different technique for alignment. There are a number of different edit distances known in the art. This technique for alignment is only generally suited to alignment of ASUs of the same language, which is another reason why it was not used in standard SMT. So because the original text and revised text are written in the same language, a much simpler implementation is possible than alignment in SMTs by the IBM models.

A wide variety of assisting in reviewing tasks can be generated by tailoring the SMT models and components to the task, as is well known in the art. One particular embodiment of a CPAR is a revision propagation engine (RPE). The resulting RPE is a system that learns to “translate” texts containing some incorrect or undesired forms of expression into text that only contain correct or desired forms of expression, based on previous corrections made by the reviewer.

Accordingly, an automated method for generating a computer program for assisting in reviewing (CPAR) method is provided. The method comprises: receiving a first original compound semantic unit (OCSU), and an outcome of a revision of the OCSU (RCSU); applying an edit distance measure between the OCSU and the RCSU to generate at least a partial alignment of atomic semantic units (ASUs) of the OCSU and RCSU; constructing a hypothesis generator by building an ASU table, including at least ASUs associated by the partial alignment of the OCSU and RCSU; and constructing a hypothesis evaluator for evaluating hypotheses by assigning weights to each of the entries in the ASU table, to define a joint count ASU table, the hypothesis generator and evaluated being built by training a translation model according to a statistical machine translation method. Therefore, a CPAR consisting of the hypothesis generator and hypothesis evaluator is enabled to receive an unrevised OCSU, and suggest, or provisionally change, the unrevised unit of speech in favour of a hypothesis, in accordance with an evaluation thereof.

Constructing the hypothesis evaluator may further comprise providing one of a language model, a distortion model, and a sentence length model. Providing a language model may comprise constructing the language model from either a list of OCSUs, or a list of RSCUs. Providing the language model may comprise constructing an input language model from a list of OCSUs, and constructing an output language model from a list of RSCUs. Constructing the hypothesis evaluator may comprise modifying a previous hypothesis evaluator that was based on a subset of the list of OCSUs or RCSUs. Constructing the hypothesis evaluator may further comprise providing a decoder for providing a scoring or ranking for a hypothesis based on two or more component models. The decoder provided may evaluate an option for not altering the unrevised OCSU regardless of the content of the unrevised OCS.

Constructing the hypothesis generator may comprise modifying a previous hypothesis generator that was based on a subtable of the ASU table. The ASU table may include ASUs associated by partial mappings from a list of all previous OCSU,RCSU pairs from a document. The ASU table may include, for each ASU in an OCSU, a row including the ASU paired with itself.

Also accordingly, a system for generating a computer program for assisting in reviewing (CPAR) is provided. The system comprises a processor with a memory encoding program instructions for receiving a first original compound semantic unit (OCSU), and an outcome of a revision of the OCSU (RCSU); applying an edit distance measure between the OCSU and the RCSU to generate at least a partial alignment of atomic semantic units (ASUs) of the OCSU and RCSU; constructing a hypothesis generator by building an ASU table, including at least ASUs associated by the partial alignment of the OCSU and RCSU; constructing a hypothesis evaluator for evaluating hypotheses by assigning weights to each of the entries in the ASU table, to define a joint count ASU table, the hypothesis generator and evaluated being built by training a translation model according to a statistical machine translation method; and outputting a CPAR comprising of the hypothesis generator and hypothesis evaluator enabled to receive an unrevised OCSU, and suggest, or change, the unrevised unit of speech in favour of a hypothesis, in accordance with an evaluation thereof.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a schematic illustration of data flow in a process showing how previous revisions to text are used to define CPARs for each revision or batch of revisions, wherein the CPARs are used for amending the text, prior to review;

FIG. 2 is a schematic illustration of principal functional blocks of a CPAR generator in accordance with an embodiment of the present invention;

FIG. 3 is a schematic illustration of a partial alignment output by an edit distance algorithm on two sentences of a common language;

FIG. 4 is a table showing properties of a set of documents used to generate and demonstrate the present invention;

FIG. 5 is a table showing results of an implementation of the present invention to improving machine translation (MT) output using the present invention;

FIGS. 6 and 7 are graphs showing a number of RPE amendments (CoPr edits), a word error rate gain, and a BLEU improvement, as a function of a weight assigned to a reference language model for two model mixing strategies (i.e. a log-linear model, LnLM; and a generalized linear model, GenLM).

### DESCRIPTION OF PREFERRED EMBODIMENTS

Herein a technique for generating a computer program for assisting in reviewing (CPAR) text documents is described. As the CPAR can be derived with very little information (such as less than a few thousand CSU pairs, or even to a single CSU pair) uses review information from a user to update components thereof, and therefore makes the iterations of CPARs increasingly adaptive to the reviewers operations.

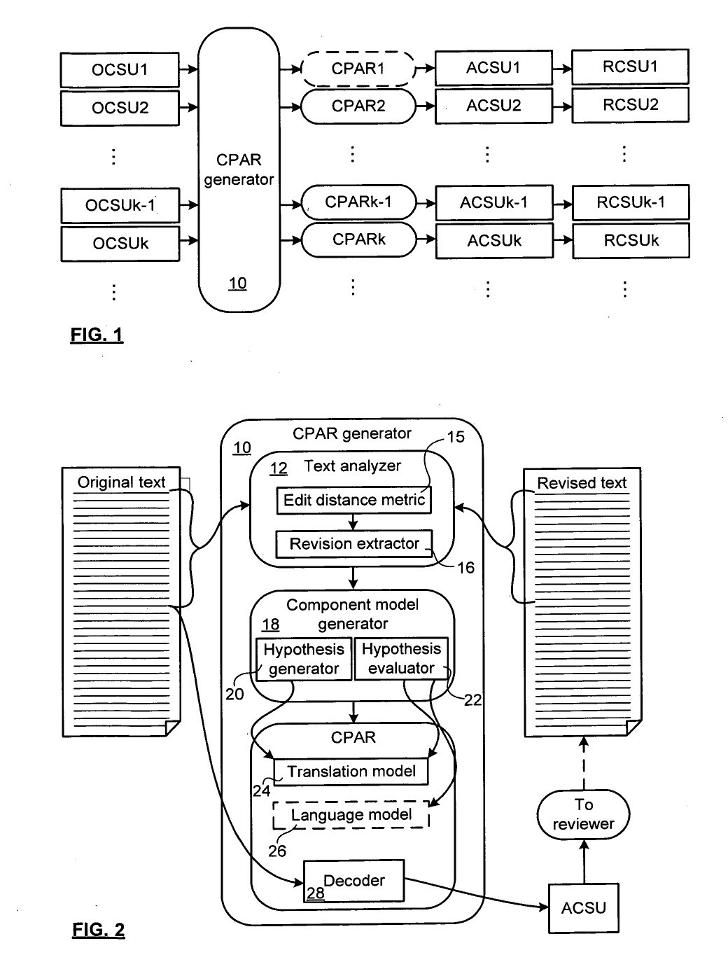

FIG. 1 is a schematic illustration of data flow in a linear process showing how a reviewer and a sequence of improved CPARs can be used to advantage. In some applications, reviewing is a sequential process that proceeds one CSU at a time, either in an order of the sentences of the document, or some other order taken by the reviewer, or directed by a revision program. In such applications, a process shown in FIG. 1 can be applied. While this linear flow may not be appropriate for all text revision environments, it is generally illustrative of the data flow, which can be more complex in other applications. In general, this process allows for previous revisions (in time) to text to be used to define CPARs, which, in turn, are used to amend (or alternatively annotate) the subsequent text in conformance with the previous revisions, prior to the reviewer receiving the text units.

In FIG. 1, a first Original CSU (OCSU1) of text is first fed to an “empty” CPAR (CPAR1). While, in other embodiments of the present invention, CPAR1 may have an initial model provided therefor, or may otherwise be primed based on exogenous data, or a priori information about a system/person that generated OCSU1, for example, it is assumed for the present example, that no such initial model is available. Accordingly, a CPAR generator 10 outputs CPAR1 which either has only a generic component model and unreviewed content of OCSU1 as its basis, or alternatively CPAR1 may not be constructed, if reviewed content is required for a meaningful CPAR to be defined. The CPAR1 (if constructed) is applied to OCSU1, to generate nominally amended or annotated CSU (ACSU1). By nominally amended or annotated, it is intended to indicate that the result of application of a CPAR to an OCSU may result in no suggested amendment. This may be frequent or rare, depending on the construction of the system and the origin of the OCSUs. So the ASCU1 may well happen to be equal to OCSU1, even if the CPAR1 is generated. The reviewer receives ACSU1, and outputs revised CSU (RCSU1), completing a first iteration. Each row of FIG. 1 shows an iteration of this process, for a respective CSU.

Each CPARn, an nth version of the CPAR, is trained specifically to revise sentence OCSUn, using information extracted from the previous OCSU and RCSU (1 . . . n−1), and possibly ACSUs. Thus the CPARn can potentially be updated with new information from an n−1th iteration of the process, and use the OCSUn in the construction of CPARn. Thus each time a RCSUn−1 exhibits a change in how the text is being treated by the reviewer, RCSUn may be updated to generate one or more improved component models of the revisions to be applied. The update may be a from-scratch process that regenerates the component model at each step, or may be an incremental update to the component model.

Naturally there are many modalities and options for implementing such a scheme. For example, the reviewer may specify for each revision whether this is one that is to be systematically made, or a confidence or rule weighting with respect to a specific change, or some information about the operation just performed on the data. Furthermore, the reviewer may specify that an annotation (in the event that the ACSUs are annotated units) was incorrect, which may modify the manner in which the component model is improved. However, such feedback from reviewers is typically time-consuming and irksome for reviewers, and may not be worth the effort. It is a particular advantage of the present invention that by simply applying the revision to the ACSUs, without knowledge of the actions that may have been taken by the CPAR, that the CPAR generator conforms to the revisions, rather than forcing the reviewer to adapt the CPAR generation.

An option that may be particularly useful in non-linear embodiments of the invention, is that corrections to the ACSUs prompt identification (such as by highlighting) of other units in the document indicating sections of the text in greatest need of review. So while FIG. 1 assumes that each OCSU is reviewed exactly once by a single human reviewer, no sentence is left unreviewed, and no sentence is reviewed more than once, this is in no way limiting on the present invention. Multiple reviewers or multiple reviews of a same OCSU need not alter the manner in which the CPARs are generated at each step.

It should be noted that both positive and negative feedback flow from the reviewer, insofar as a RCSUs that matches the ACSU, or the OCSU, and that with sufficient numbers of examples, an CPAR may be expected to converge on good performance for the intention of the document.

It is an advantage to use SMT-like models for translating OCSUs into ACSUs in accordance with the present invention, because the component model training performed according to SMT methods naturally accommodates global information about the corrections, and provides a natural way to supplement decision making with regards to what revisions to propagate and which not to, with grammatical-linguistic knowledge embedded in SMT systems.

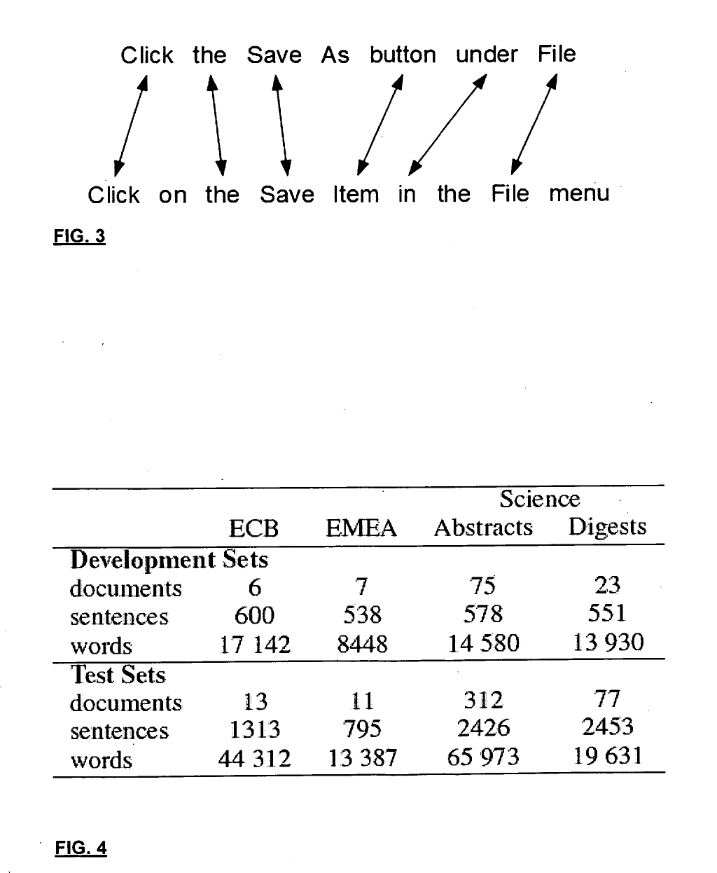

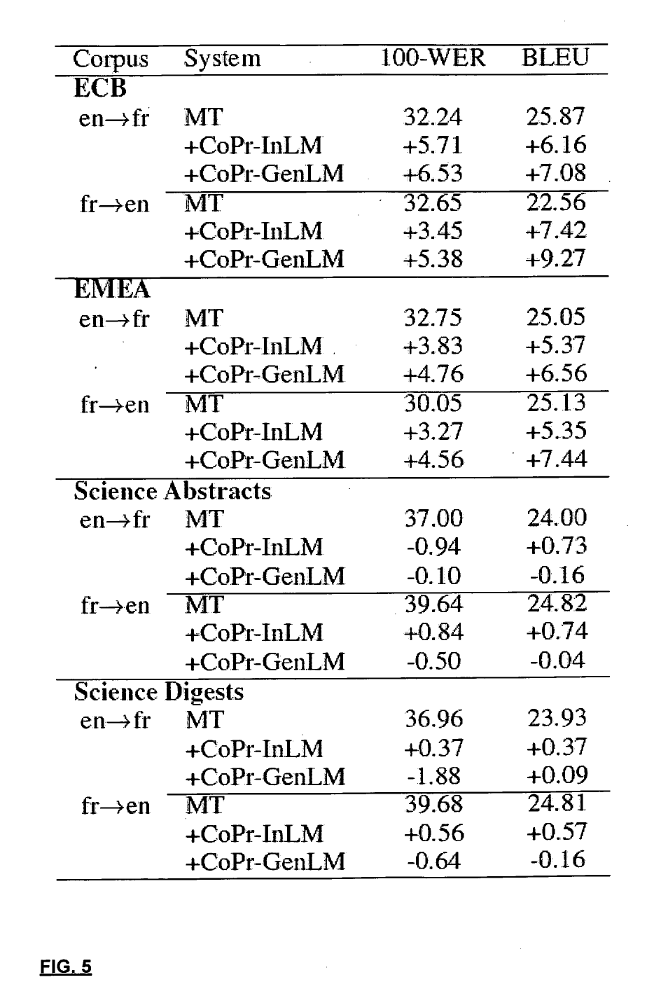

FIG. 2 is a schematic illustration of a CPAR generator 10. The CPAR generator 10 takes OCSUs, and their corresponding RCSUs, and feeds them as ordered pairs to a text analyzer 12. The text analyzer includes a text aligner that applies an edit distance metric 15, to identify a (shortest) edit distance that transforms OCSUs to their associated RCSUs. Once the (shortest) edit distance is determined (or at the same time), a set of transformations that accomplishes the transformation is determined. The set of transformations is used to generate at least partial mappings of ASUs of the OCSUs onto the RCSUs' ASUs. This partial mapping (complete if OCSU=RCSU), may be augmented with information regarding unmapped elements, or associations of substitutable words, in some embodiments.

The edit distance metric is used to identify a list of edits that transform OCSUs into RCSUs (or vice-versa). As an example, a well-known dynamic programming algorithm for the Levenshtein distance (Wagner and Fischer, 1974), extracts a sequence of edit operations as a byproduct. The operations are: insert, delete, substitute, and no-edit. FIG. 3 is an illustrative example of how the Levenshtein distance may be used to compute an edit distance on two sentences: ‘Click the Save As button under File’=OCSU; and RCSU=‘Click on the Save item in the File menu’. The output of the dynamic programming algorithm (the lowest distance list of edits) may be: no-edit (Click), insert (on), no-edit (Save), delete (As), substitute (button, item), etc., leading to a partial text alignment defined by at least the no-edit marks.

From this sequence, an alignment is provided as diagrammed in FIG. 3, for example by mapping ASUs that appear within no-edit and substitute operations. A Damerau-Levenshtein distance can be used instead (Wagner and Lowrance, 1975), which also features transposition of two adjacent words as another transformation. If the Damerau-Levenshtein distance is used, words appearing within transposition operations could also be considered mapped. Selection from a variety of edit distances, and assignment of the costs of the types of operations, etc., and ranking of the shortest distance, are within the purview of someone of ordinary skill.

Referring again to FIG. 2, once the partial mapping (or an enhancement thereof) is provided, a revision extractor 16 is invoked to take the partial mapping and output an alignment of the OCSU and RCSU. This revision extractor 16 therefore takes the information of the revisor into account for generating the component models.

By analogy with phrase-based SMT terminology, the alignment by the edit distance metric provides an ASU-aligned bilingual (though strictly monolingual) corpus, such as required for training SMT component models. The revision extractor, then outputs this ASU mapping. For example, from the alignment in FIG. 3, the following associations could be produced (among many others): (Click, Click), (Click the, Click on the), (Click the, Click on), (Click the Save, Click on the Save), (the, on the), (Save As, Save), (Save As button, Save item), (As button, item), (button, item), etc. Many of these are not grammatical/semantic substitutions in a broad class of sentences, or worthy revisions for the intended review, but statistics regarding these pairs are used to discern and weight them by component models.

The associations are forwarded to a component model generator 18, which assembles a hypothesis generator 20, in the form of a table of ASU pairs. Some culling, expansion, or variation of the associated pairs may be performed to form the entries in the ASU table, using known techniques. This is performed while applying known SMT methods for generating a translation model (TM) 24 (e.g. Koehn et al., 2007, although a variety of these methods are known). TM generation has typically been done by very large computation systems with vast resources, to cope with large counts of data. However, given the very small amount of text analyzed in this present setting, it can be performed in a runtime environment with an ordinary personal computer as a thread in a document processing or reviewing system. The generation of the translation model by SMT methods also involves counting the entries in the ASU table, to generate a joint count ASU table. The joint count ASU table encodes information for evaluating hypotheses, as well as hypothesis generators. Each ASU pair in the joint count ASU table denotes a possible transformation that the decoder can use to produce an ACSU from an OCSU (with that ASU), and a probability of the ASU being a good change can at least partially be gaged by the joint count of the ASU pair.

To each ASU within the joint count ASU table (or other data structures of language models), values can be attached. These values may be used by the decoder when evaluating the relative merits of different hypotheses, to define scores. There is a vast literature on the subject, of which the person of ordinary skill is expected to be aware. These values may be used for evaluating hypotheses, and producing these values and systems for evaluating based on these values, is performed by the component model generator, to define the CPAR.

Similarly one or more language models (LM) 26 may be trained for the CPAR, to assist in the evaluation of candidate translations. Conceptually, each LM can be viewed as a function that takes candidate ACSU, and outputs a value (typically a probability estimate) reflecting how much the candidate “looks like” natural language. SMT systems typically rely on n-gram language models such as those described in (Chen and Goodman, 1996) that need to be trained on relevant data.

While it is generally infeasible to generate SMT translation models, language models, reordering or distortion models, sentence length models, and other components that make up an SMT system, without extensive use of computer resources, the task of generating joint count ASU tables with a sparse set of data is computationally inexpensive, resulting in the feasibility of generating translation models for a CPAR, in real-time. Some of these component models would typically be updated less frequently than others, and some need never be recomputed. For example, a sentence length model, or a generic language model, may never be updated in response to new OCSU-RCSU pairs. It will be noted that each of the component models can be seen as hypothesis generators and/or hypothesis evaluators, and that other component models, not typically used for language translation, may be used for particular assisting in reviewing tasks for particular applications.

From-scratch component model generators are well known from the SMT literature. Specific algorithms for accomplishing incremental updates of TMs and LMs are not commonly used, and risk being complicated, however, it will be appreciated that statistics for a joint count ASU table can be represented in a manner favourable to independently incrementing numerators and denominators, and indexing the words in the OCSU to allow for incremental adjustment of the joint count ASU table in light of a single new OCSU-RCSU pair, resulting in perhaps a few dozen ASU pairs. Furthermore approximative methods may be used for updating. Substantial savings of computer resources may be accomplished by incrementally updating, rather than recreating particular component models, however updating the model is not essential for the system to perform efficiently with reasonably sized documents. So while, in the examples below, Applicant generates CPARs “from scratch”, in practice this process can equally be viewed (and implemented) as incremental training.

A translation model 24 embodies a hypothesis generator 20. It produces a number of candidate “translations” for each OCSU, and typically gives an initial weight to that hypothesis. The language models 26, and the rest, are generally independent hypothesis evaluators. Whenever a plurality of evaluators are provided, a mixing procedure is required for the decoder to assign weights to each of the independent evaluators. This may be provided by an off-line optimization, based on a development corpus, in a manner known in the art. Alternatively a set of weights can be provisionally assigned, and a slow-changing process can be used to use feedback inherent in numbers of the RCSUs (for example) to gradually modify parameters of the mixing procedure.

The mixing procedure is incorporated in a SMT decoder 28 that uses the component models to output an ACSU corresponding to the next unreviewed OCSU. The decoder 28 performs the automatic corrections on the OCSU that the reviser is yet to receive. The ACSU is then forwarded to the reviewer, and will reduce a number of repeated instances of same corrections being made by the reviewer. The ACSU may then be reviewed and associated with another RCSU by the reviewer, bringing the process back to the beginning.

In practice, a CPAR can use a standard phrase-based decoder algorithm, such as described in (Koehn et al., 2007) inter alia. In a CPAR, as in SMT systems, scores coming from various components of the component models (joint count ACU tables, language models, etc.) may be combined within a log-linear model, then optimized using one of various methods, such as Minimum Error Rate Training (Och, 2003) or batch-MIRA (Cherry and Foster, 2012), in such a way as to maximize some given criterion, for example a BLEU score (Papineni et al., 2002). In SMT, these procedures normally assume a development data set, which is repeatedly translated with a single translation system. In the present setting, optimizing the components with a development data set may be difficult. A development data set may be encoded by the previous list of OCSEs and RCSEs, but it may be computationally expensive to optimize the decoder 28 at each generation step. A generic assignment for components may be provided by analyzing a development data set prior to implementation of the component model generator, independently of the particular OCSEs and RCSEs received. It is nevertheless possible to find a set of para-meters that is globally optimal under an assumed variety of revisions. The generic assignment may vary with a population of the one or more component models, so that as more revised text is available for analysis, the specific revision information is weighted more strongly. The degree to which the assisting in revising task is constrained may have a significant impact on how the components are defined and combined.

In practice it may not be convenient to combine the scores from multiple hypothesis evaluator component models with a log-linear model as described above. Hypothesis evaluator component models that are trained on very little data, are likely to produce near-zero scores for most ASUs. A preferred approach is to combine the parameters using a linear mixture, as proposed by Foster et al. (2007). The relative weight of each LM may then be controlled by a single parameter. These parameters can be optimized automatically so as to maximize BLEU score, using grid-search or Monte Carlo optimization. This optimization may be performed off-line, using a development corpus, in a manner known in the art. Alternatively a set of weights can be provisionally assigned, and a slow-changing process can be used to leverage feedback inherent in differences between the OCSUs and RCSUs (for example) to gradually modify parameters of the mixing procedure.

### Input-Output Polarization

Having described the general structure of FIG. 2, the following illustrates one organizational principle that can be helpful for designing component models of a CPAR. It will be appreciated that just because a correction has been observed in the past does not mean it should be re-applied systematically to all further input. For example, consider the observed corrections in FIG. 3: from this example, it is possible to conclude that the word “the” should systematically be replaced by “on the”; or that is the substitution of “under” by “in the” should be performed. Clearly, such corrections should not be applied blindly. A CPAR must take context into consideration when selecting between different options, and not applying any correction. Otherwise said, applying a correction of the form (X, X)) should always be an option. The option for explicitly allowing the CPAR to “do-nothing” may be encoded as a separate decision for the decoder, or may be included in the candidate generator, and may further be given particular weight by the candidate evaluator.

For example, one embodiment will have two kinds of translation models (TMs) and LMs: input and output. Input TMs are created using only information coming from the OCSUs (matched with itself); and output models are created using combined information from the paired OCSU-RCSU. Input LMs are created using only OCSUs, whereas output LMs are created to recognize RSCUs (either by only containing RSCUs or by using other good examples of revised text). The distinction is based on the idea that while output component models push for aggressive changes to the OCSUs, the input component models act as inertia, inhibiting the application of corrections.

The input TMs and output TMs may be embodied as distinct joint count ASU tables, such that the input TMs may be understood to favour “Null” corrections, whereas the output TMs favour changes. The output TM is analogous to what is normally used in a SMT system: it contains all paired ASUs extracted. Paired ASUs extracted implicitly contain all previously observed revisions.

The input TM's ASU pairs explicitly sanction leaving the ASU unedited. Creating such a joint count ASU table for CPAR can be achieved by extracting all ASU pairs resulting from aligning the current sentence with itself. Inclusion of these ASU pairs in the null corrections joint count ASU table ensures that the pair of sentences (OCSU,OCSU) is always a recognized possibility. The input TM may bay constructed using all CSUs of the document prior to revision, by listing all OCSUs (paired with itself) that will be presented to the reviewer. Alternatively, at each generation of a CPAR, a set of one or more instant OCSU may be presented for ASU mapping to generate the joint count ASU table. Setting the input and output TMs in opposition to each other may be preferred to ensure that correction and status quo options are evaluated.

Similarly, the CPAR may include input and output LMs used by the decoder to evaluate competing hypotheses. Thus an input LM may be trained on segments from the OCSUs, and, as a result, it will tend to assign higher scores to things that look like uncorrected texts. Conversely, an output LM may be trained using RCSUs, and therefore will favor sentences that look more like corrected text.

### Evaluation Components

The LM training sets are typically very small; this results in relatively weak LM's, which is likely to result in systems that apply revisions with little regard for the fluency of the output. One solution to this problem is to complement the input and output LM with LMs trained on larger amounts of data. In-domain or related target language material can be used if available; otherwise, even out-of-domain, generic data can be useful. In our experiments we used a generic output LM, trained on a very large corpus harvested from the Web. Such generic language models trained (off-line) from a general or specific domain of discourse may be added to the CPAR thus generated, and this will not need to be regenerated at each step.

As is well known in the art, there are a wide range of LMs and TMs that have been built specifically for respective assisting in reviewing purposes. Some of these may have particular inclusion of paraphrases, common mistakes, and other features that are particular to the assisting in reviewing task. One advantage of using the SMT structure for the CPAR is that the variety of SMT components (typically called models) can be readily incorporated into the decision making procedure, and a balance can be made with the specific information provided by the reviewer.

### Experiments

An implementation of a revision propagation engine (RPE) generator, an example of a CPAR described above, was produced and tested in the specific application context of machine translation post-editing. In this application scenario, the original text is a machine translation of a text in a different language, that was produced automatically by a machine translation (MT) system.

The potential of the RPE was evaluated by simulation. The CSUs were sentences; the ASUs, phrases. The original text was a machine translation output of a source-language text, for which a reference translation was available. For each original sentence, a RPE was generated, and used to produce amended sentences. We took the reference sentences as revised sentences. In theory, this sort of simulated experiment is a worst case scenario for RPEs, because in some situations, the revised sentences can be substantially different from amended sentences. Nevertheless, the effectiveness of the system can be demonstrated by showing that the RPEs reduce the amount of manual editing required, i.e. that amended sentences to revised sentences is closer than original sentences to revised sentences.

A “generic” SMT system, i.e. a system not adapted to a particular text domain or genre, was used to produce the OCSUs, from CSUs in a (different) source language. Specifically the system was built using Portage, a typical phrase-based MT platform, which has achieved competitive results in recent WMT (Larkin et al., 2010) and NIST evaluations. The SMT system was trained using a very large corpus of English-French Canadian government data harvested from the Web (domain gc.ca), containing over 500M words in each language. The following feature functions in the log-linear model of the Portage system were used: a 5-gram language model with Kneser-Ney smoothing (1 feature); relative-frequency and lexical translation model probabilities in both directions (4 features); lexicalized distortion (6 features); and word count (1 feature).

The parameters of the log-linear model were tuned by optimizing BLEU on the development set using the batch variant of MIRA (Cherry and Foster, 2012). Phrase extraction was done by aligning the corpus at the word level using both HMM and IBM2 models, using the union of phrases extracted from these separate alignments for the phrase table, with a maximum phrase length of 7 tokens. Phrase pairs were filtered so that the top 30 translations for each source phrase were retained.

Components of the Portage platform were also used to implement the automatic correction system needed in the RPE. The components of that system were set up as described above, and the log-linear model combines the following feature functions: linear mixture language model (1 feature); relative-frequency translation model probabilities in both directions (2 features); and word count (1 feature). Phrases were limited to 7 tokens. The input LM and output LM used in the LM mixture are trigram models with Witten-Bell smoothing; the Generic LM's are similar to those used by the MT system above. All components are trained on true case data; the intention is to capture case-related corrections.

The experimental data consisted of documents, i.e. sequences of sentences. We have limited document size to 100 sentences, to limit the effect of larger documents biasing the results (longer documents were truncated). Intuitively, 100 sentences approximately correspond to the daily production of a professional translator.

Specifically, the test documents were extracted from the ECB and EMEA corpora of the OPUS corpus (Tiedemann, 2009), and a collection of scientific abstracts from Canadian publications. French and English versions of these datasets were used, and experiments were performed in both translation directions. The choice of the test data was motivated by their technical and specialized nature: EMEA and ECB contain much internal and domain-specific repetition, and the technical nature of the documents makes them particularly difficult for a generic MT system. The collection of scientific abstracts is also highly technical, but most documents are very short, even though we excluded abstracts shorter than 5 sentences. Therefore, each document contains little internal repetition. To better understand the effect of document length, we examined the effect of RPE on this corpus under two different conditions: with abstracts considered as individual documents, and grouping multiple abstracts from the same journal and year into a single “digest”. Details of our experimental data can be found in Table 1.

The development sets used to optimize the parameters of the RPE were intentionally made relatively small, on the order of 10-15K words. Intuitively, this is intended to correspond to about a week's worth of human post-editing. In a real-life setting, this data could be collected during a “warm-up” period. Alternatively, the system could be initially deployed with random parameters, and its parameters periodically re-optimized.

We tested our approach on all datasets, under two different conditions: first by mixing the output LM of the RPE with input LM as described above; and second by mixing the output LM with a background model, trained on large amounts of “general language” data (Generic LM)—in effect, this Generic LM replaces the input model in these experiments. The weight of the output LM was manually set to 0.9 in the linear mixture with the input LM and to 0.5 when combining with the Generic LM.

Table 2 presents the results of these experiments. The impact of RPE is measured in terms of WER and BLEU gain (for convenience, we report WER scores as 100-WER, so that larger values denote better translations, and negative “gains” can be interpreted as “losses”). For each corpus, and language, we first report the scores obtained by the raw machine translation, prior to performing RPE (MT), then the effect of RPE mixing the Output LM with the Input LM (+RPE-InLM), and last the effect of RPE mixing the Output LM with the Generic LM (+RPE-GenLM).

For the ECB and EMEA corpora, RPE has a clear positive impact: WER is reduced by 3.27 to 6.53, while BLEU increases by 5.35 to 9.27. Mixing the output LM with a generic background LM (+RPE-GenLM) appears to work better than with a locally-trained input LM (+RPE-InLM). This is not entirely surprising: While the input LM knows little more than how to do nothing, the Generic LM is a rich source of additional knowledge that the RPE can exploit to produce more fluent translations.

The Science corpora illustrate situations where RPE is unlikely to significantly reduce the work of the reviser. In fact, in some of these conditions, RPE slightly increases post-editing effort, as measured with WER and BLEU. In practice, the Science abstracts are simply too short to contain document-internal repetition that RPE can exploit advantageously (average length of documents is 7.7 sentences). When combined into yearly digests, the documents become substantially larger (31.9 sentences per document), but they are too heterogeneous to contain any exploitable repeated corrections.

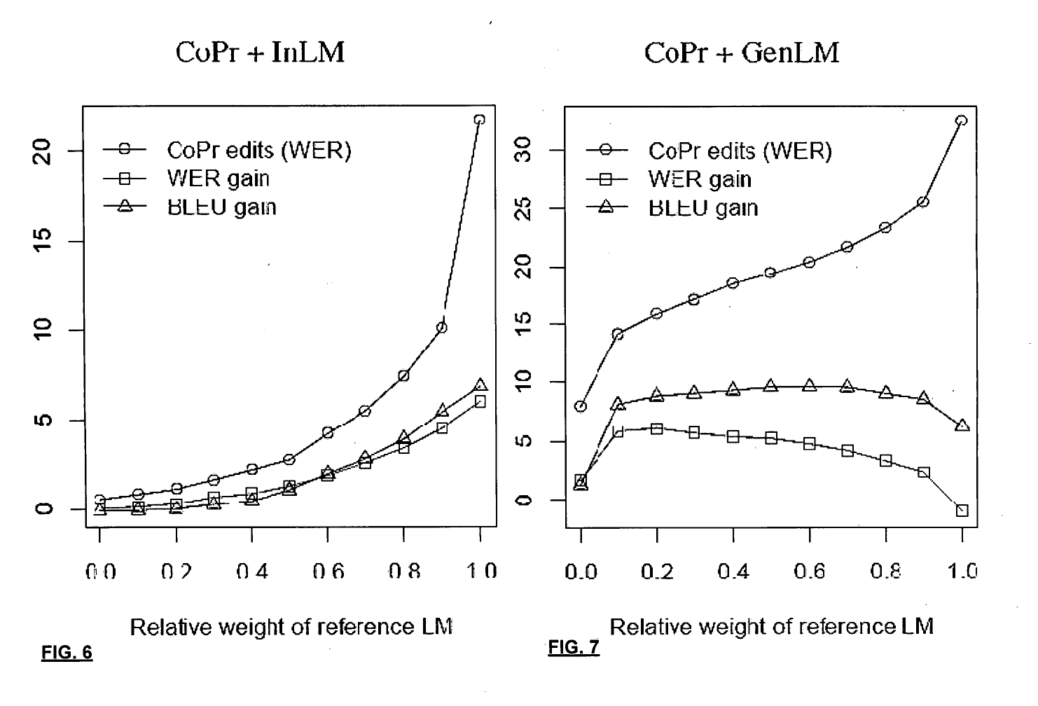

It is instructive to examine the behavior of the RPE as we vary the relative weight of the Output LM in the LM mixture. This is shown for the ECB fr→en development set in FIGS. 6 and 7. The curve defined by circles ∘ denotes the amount of edits performed by the RPE, measured in terms of WER (on a scale of 0-100). FIG. 6 (“CoPr+InLM”) illustrates the situation for mixtures with the input LM, which is intended to implement the do-nothing option. When all the weight is assigned to the input LM, the RPE performs virtually no changes to its MT input; conversely, assigning all the weight to the output LM results in more than 20% of the words being edited. Between these two extremes, the amount of RPE edits grows more-or-less monotonically. WER and BLEU gains (square □ and triangular A curves, respectively) appear to follow the same kind of progression. This suggests that, while assigning more weight to the input LM does make the system less aggressive, it does not make it more discriminant: RPE corrections are inhibited regardless of their potential value for the reviewer.

This contrasts with FIG. 7 (“CoPr+GenLM”), which corresponds to mixtures with a rich background LM. Here again, the amount of RPE corrections increases dramatically as more weight is assigned to the output LM. Here, however, WER and BLEU gains follow a different pattern, displaying optimal values somewhere between the two extreme settings. (Interestingly, in this case, the outcome will be substantially different whether we optimize relative to WER or BLEU; this behavior is not generalized, however.) The Generic LM provides additional information, which the RPE can exploit to make better decisions. This suggests that, when such a background LM is available, it makes sense to automatically optimize its relative weight on development data.

In conclusion, a method for generating an RPE has been described using a phrase-based SMT system. Experiments simulating post-editing sessions suggest that our method is particularly effective when revising technical documents with high levels of internal repetition. However, our method is in no way restricted to post-editing machine translations. Rather, it can be applied to any text revision task: the draft may be an original or a translation and it may have been produced by a human or a machine. Because the method is designed to work with extremely small amounts of training data, it can be implemented into an efficient, lightweight process.

References: The contents of the entirety of each of which are incorporated by this reference:
Béchara, Hanna, Yanjun Ma, and Josef van Genabith. 2011. Statistical post-editing for a statistical mt system. MT Summit XIII, pages 308-315.
Brown, Peter F, Vincent J Della Pietra, Stephen A Della Pietra, and Robert L Mercer. 1993. The mathematics of statistical machine translation: Parameter estimation. Computational linguistics, 19(2):263-311.
Cer, D., C. D. Manning, and D. Jurafsky. 2010. The Best Lexical Metric for Phrase-Based Statistical MT System Optimization. In Human Language Technologies: The 2010 Annual Conference of the North American Chapter of the Association for Computational Linguistics, pages 555-563.
Chen, Stanley F and Joshua Goodman. 1996. An empirical study of smoothing techniques for language modeling. In Proceedings of the 34th annual meeting on Association for Computational Linguistics, pages 310-318. Association for Computational Linguistics.
Cherry, Colin and George Foster. 2012. Batch tuning strategies for statistical machine translation. In Proc. of NAACL, volume 12, pages 34-35.
Church, K. W. and W. A. Gale. 1995. Poisson mixtures. Natural Language Engineering, 1(2):163-190.
Dugast, Loïc, Jean Senellart, and Philipp Koehn. 2007. Statistical post-editing on systran's rule-based translation system. In Proceedings of the Second Workshop on Statistical Machine Translation, pages 220-
Foster, George and Roland Kuhn. 2007. Mixture-model adaptation for SMT. In WMT 2007.
Gong, Z., M. Zhang, and G. Zhou. 2011. Cache-based document-level statistical machine translation. In EMNLP 2011.
Hardt, Daniel and Jakob Elming. 2010. Incremental re-training for post-editing smt. In AMTA 2010.
Knight, Kevin and Ishwar Chander. 1994. Automated postediting of documents. In Proceedings of the National Conference on Artificial Intelligence, pages 779-779. JOHN WILEY & SONS LTD.
Koehn, Philipp, Hieu Hoang, Alexandra Birch, Chris Callison-Burch, Marcello Federico, Nicola Bertoldi, Brooke Cowan, Wade Shen, Christine Moran, Richard Zens, et al. 2007. Moses: Open source toolkit for statistical machine translation. In Proceedings of the 45th Annual Meeting of the ACL on Interactive Poster and Demonstration Sessions, pages 177-180. Association for Computational Linguistics.
Lagarda, A-L, Vicent Alabau, Francisco Casacuberta, Roberto Silva, and Enrique Diaz-de Liano. 2009. Statistical post-editing of a rule-based machine translation system. In Proceedings of Human Language Technologies: The 2009 Annual Conference of the North American Chapter of the Association for Computational Linguistics, Companion Volume: Short Papers, pages 217-220. Association for Computational Linguistics.
Larkin, Samuel, Boxing Chen, George Foster, Ulrich Germann, Eric Joanis, Howard Johnson, and Roland Kuhn. 2010. Lessons from NRC's Portage system at WMT 2010. In Proceedings of the Joint Fifth Workshop on Statistical Machine Translation and Metrics-MATR, pages 127-132. Association for Computational Linguistics.
Levenberg, Abby, Chris Callison-Burch, and Miles Os-borne. 2010. Stream-based translation models for statistical machine translation. In NAACL 2010.
Nepveu, Laurent, Guy Lapalme, Philippe Langlais, and George Foster. 2004. Adaptive language and translation models for interactive machine translation. In EMNLP 2004.
Och, Franz Josef. 2003. Minimum error rate training in statistical machine translation. In Proceedings of the 41st Annual Meeting on Association for Computational Linguistics-Volume 1, pages 160-167. Association for Computational Linguistics.
Papineni, Kishore, Salim Roukos, Todd Ward, and Wei-Jing Zhu. 2002. Bleu: a method for automatic evaluation of machine translation. In Proceedings of the 40th annual meeting on association for computational linguistics, pages 311-318. Association for Computational Linguistics.
Schwenk, Holger, Sadaf Abdul-Rauf, Loïc Barrault, and Jean Senellart. 2009. Smt and spe machine translation systems for wmt'09. In Proceedings of the Fourth Workshop on Statistical Machine Translation, pages 130-134. Association for Computational Linguistics.
Simard, M., C. Goutte, and P. Isabelle. 2007. Statistical Phrase-based Post-editing. In Proceedings of NAACL HLT, pages 508-515.
Ehara, Terumasa. 2007. Rule based machine translation combined with statistical post editor for japanese to english patent translation. In Proceedings of the MT Summit XI Workshop on Patent Translation, volume 11, pages 13-18.
Tiedemann, Jörg. 2009. News from OPUS-A collection of multilingual parallel corpora with tools and interfaces. In Recent Advances in Natural Language Processing, volume 5, pages 237-248.
Tiedemann, Jörg. 2010. Context adaptation in statistical machine translation using models with exponentially decaying cache. In DANLP.
Wagner, Robert A and Michael J Fischer. 1974. The string-to-string correction problem. Journal of the ACM (JACM), 21(1):168-173.
Wagner, Robert A and Roy Lowrance. 1975. An extension of the string-to-string correction problem. Journal of the ACM (JACM), 22(2):177-183.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. An automated method for generating a computer program for assisting in reviewing (CPAR), the method comprising:
receiving a first original compound semantic unit (OCSU), and an outcome of a revision of the OCSU (RCSU);
applying an edit distance measure between the OCSU and the RCSU to generate at least a partial alignment of atomic semantic units (ASUs) of the OCSU and RCSU;
constructing a hypothesis generator by building an ASU table, including at least ASUs associated by the partial alignment of the OCSU and RCSU; and
constructing a hypothesis evaluator for evaluating hypotheses by assigning weights to each of the entries in the ASU table, to define a joint count ASU table, the hypothesis generator and evaluated being built by training a translation model according to a statistical machine translation method;
whereby the CPAR consisting of the hypothesis generator and hypothesis evaluator is enabled to receive an unrevised OCSU, and suggest, or provisionally change, the unrevised unit of speech in favour of a hypothesis, in accordance with an evaluation thereof.

2. The method of claim 1 wherein constructing the hypothesis evaluator further comprises providing one of a language model, a distortion model, and a sentence length model.

3. The method of claim 2 wherein providing a language model comprises constructing the language model from either a list of OCSUs, or a list of RSCUs.

4. The method of claim 1 wherein constructing the hypothesis generator comprises modifying a previous hypothesis generator that was based on a subtable of the ASU table.

5. The method of claim 3 wherein constructing the hypothesis evaluator comprises modifying a previous hypothesis evaluator that was based on a subset of the list of OCSUs or RCSUs.

6. The method of claim 1 wherein the ASU table includes ASUs associated by partial mappings from a list of all previous OCSU,RCSU pairs from a document.

7. The method of claim 2 wherein providing the hypothesis evaluator further comprises providing a decoder for providing a scoring or ranking for a hypothesis based on two or more component models.

8. The method of claim 7 wherein the decoder provided evaluates an option for not altering the unrevised OCSU regardless of the content of the unrevised OCSU.

9. The method of claim 2 wherein providing the language model comprises constructing an input language model from a list of OCSUs, and constructing an output language model from a list of RSCUs.

10. The method of claim 1 wherein the ASU table includes, for each ASU in an OCSU, a row including the ASU paired with itself.

11. A system for generating a computer program for assisting in reviewing (CPAR), the system comprising a processor with memory encoding program instructions for:
receiving a first original compound semantic unit (OCSU), and an outcome of a revision of the OCSU (RCSU);
applying an edit distance measure between the OCSU and the RCSU to generate at least a partial alignment of atomic semantic units (ASUs) of the OCSU and RCSU;
constructing a hypothesis generator by building an ASU table, including at least ASUs associated by the partial alignment of the OCSU and RCSU;
constructing a hypothesis evaluator for evaluating hypotheses by assigning weights to each of the entries in the ASU table, to define a joint count ASU table, the hypothesis generator and evaluated being built by training a translation model according to a statistical machine translation method; and
outputting a CPAR comprising of the hypothesis generator and hypothesis evaluator enabled to receive an unrevised OCSU, and suggest, or change, the unrevised unit of speech in favour of a hypothesis, in accordance with an evaluation thereof.

12. The system of claim 12 wherein the CPAR further comprises one of a language model, a distortion model, and a sentence length model.

13. The system of claim 12 wherein the program instructions for constructing a hypothesis evaluator comprise instructions for constructing a language model from either a list of OCSUs, or a list of RSCUs.

14. The system of claim 12 wherein the program instructions for constructing the hypothesis generator modify a previous hypothesis generator that was based on a subtable of the ASU table.

15. The system of claim 14 wherein the program instructions for constructing the hypothesis evaluator modify a previous hypothesis evaluator that was based on a subset of the list of OCSUs or RCSUs.

16. The system of claim 12 wherein the ASU table includes ASUs associated by partial mappings from a list of all previously reviewed OCSU,RCSU pairs from a document.

17. The system of claim 12 wherein the program instructions for providing the hypothesis evaluator associate a decoder with the CPAR, the decoder providing a scoring or ranking for hypotheses based on two or more component models.

18. The system of claim 12 wherein the decoder evaluates an option for not altering the unrevised OCSU regardless of the content of the unrevised OCSU.

19. The system of claim 13 wherein the language model comprises an input language model base on a list of OCSUs, and an output language model based on a list of RSCUs.

20. The system of claim 1 wherein the ASU table includes, for each ASU in an OCSU, a row including the ASU paired with itself.
